(19) United States
(12) Patent Application Publication
(10) Pub. No.: US 2016/0201872 A1
(43) Pub. Date: Jul. 14, 2016

(54) TRANSFORMABLE LAMP SHADE AND LIGHTING APPARATUS INCLUDING THE SAME

(71) Applicant: I2M Co., Ltd., Daejeon (KR)

(72) Inventor: Dong Yeon CHO, Daejeon (KR)

(21) Appl. No.: 14/930,663

(22) Filed: Nov. 3, 2015

(30) Foreign Application Priority Data
Jan. 12, 2015 (KR) 10-2015-0004133

(51) Int. Cl. F21V 1/14

(52) U.S. Cl. CPC F21V 1/146

(57) ABSTRACT

A transformable lamp shade comprises a supporting bracket coupling or decoupling from a shaft or a supporting member, a cover connected to the supporting bracket and including a plurality of pleated sheets foldable in an accordion shape, a cover plate connected with the supporting bracket and the cover, a ring coupler provided to pass through the cover plate and the cover to join together the cover and the cover plate, the ring coupler having a changeable diameter, wherein as the cover plate pivots about the ring coupler, the cover changes its shape, and a link having a first end pivotally connected with the supporting bracket and a second end connected with the ring coupler to move up or down the ring coupler.

### CROSS-REFERENCE TO RELATED APPLICATIONS

This patent application claims priority under 35 U.S.C. §119 to Korean Patent Application No. 10-2015-0004133, filed on Jan. 12, 2015, in the Korean Intellectual Property Office, the disclosure of which is incorporated by reference herein in its entirety.

### TECHNICAL FIELD

Embodiments of the present disclosure concern lamps, lights, or other lighting apparatuses and lamp shades, and more specifically, to transformable lamp shades and lighting apparatus including the same.

### DISCUSSION OF RELATED ART

A lampshade is a fixture that covers the lightbulb on a lamp to diffuse the light it emits. Conical, cylindrical, and other forms on floor-, desk- or table top-mounted as well as suspended lamp models are the most common and are made in a wide range of materials. The lampshade can also apply to the glass hung under many designs of ceiling lamp. Beyond its practical purpose, significant emphasis is also usually given to decorative and aesthetic features.

Various lampshades came into the market. Conventional lampshades, however, typically have an unchanged shape and fail to live up to the needs of various users who desire aesthetic changes in shape. Further, such types of lampshades cannot adjust the amount of light emitted from the lamps.

There are a few types of lampshades transformable or light-adjustable. However, such lampshades are mostly tricky to handle or require a complicated mechanism to make desired design changes.

Therefore, there is a need for a type of lampshade that may satisfy the user's desire for decorative and practical effects.

### SUMMARY

According to an embodiment of the present disclosure, a transformable lamp shade comprises a supporting bracket coupling or decoupling from a shaft or a supporting member, a cover connected to the supporting bracket and including a plurality of pleated sheets foldable in an accordion shape, a cover plate connected with the supporting bracket and the cover, a ring coupler provided to pass through the cover plate and the cover to join together the cover and the cover plate, the ring coupler having a changeable diameter, wherein as the cover plate pivots about the ring coupler, the cover changes its shape, and a link having a first end pivotally connected with the supporting bracket and a second end connected with the ring coupler to move up or clown the ring coupler.

According to an embodiment of the present disclosure, a lamp shade comprises a supporting bracket detachably coupled with a supporting member, a cover coupled with the supporting bracket and including a plurality of pleated foldable sheets, a cover plate coupled with the supporting bracket and the cover, a ring coupler passing through and coupled with the cover plate and the cover, the ring coupler formed of a shrinkable material, wherein the cover plate is pivoted about the ring coupler to change the shape of the cover, and a link having a first end pivotally connected with the supporting bracket and a second end connected with the ring coupler to move up or down the ring coupler.

According to an embodiment of the present disclosure, a lighting apparatus comprises the transformable lamp shade. The supporting member is a socket to which a bulb is detachably coupled.

The cover plate includes a handle at a first end thereof and a rounded portion at a second end opposite the first end and through which the ring coupler is inserted. The width of the cover plate increases from the handle to the rounded portion. The rounded portion has a through-hole through which a pivoting member is inserted to enable the cover plate to pivot about the ring coupler.

The pivoting member includes a body, a disc-shaped sprocket provided in the body, coupled with an end of the link, having the link coupler pass therethrough, and having a toothed outer edge, a locking rod provided in the body elastically stuck to the toothed edge of the sprocket to control the pivoting of the cover plate, and a spring provided in the locking rod.

The body has a housing jaw to elastically support an end of the spring and a rot jaw to elastically support another end of the spring.

The cover plate includes a first plate and a second plate, and wherein a plurality of elastic clamps couple with edges of the first and second plates to fasten the first and second plates.

### BRIEF DESCRIPTION OF DRAWINGS

A more complete appreciation of the present disclosure and man of the attendant aspects thereof will be readily obtained as the same becomes better understood by reference to the following detailed description when considered in connection with the accompanying drawings, wherein:

FIG. 1 is a perspective view illustrating a lighting apparatus having a transformable lamp shade according to an embodiment of the present disclosure;

FIG. 2A is a cross-sectional view illustrating, a lighting apparatus having a transformable lamp shade wherein the transformable lamp shade is in a first shape, according to an embodiment of the present disclosure.

FIG. 2B is a cross-sectional view illustrating a lighting apparatus having a transformable lamp shade wherein the transformable lamp shade is in a second shape, according to an embodiment of the present disclosure.

FIG. 3 is an exploded perspective view illustrating a lighting apparatus having a transformable lamp shade according to an embodiment of the present disclosure;

FIG. 4A is an exploded perspective view illustrating a supporting frame of a lighting apparatus having a transformable lamp shade according to an embodiment of the present disclosure;

FIG. 4B is an expanded view illustrating a portion of the supporting frame of FIG. 4A, according to an embodiment of the present disclosure;

FIG. 5A and 5B are views illustrating an example in which a lighting apparatus having a transformable lamp shade works according to an embodiment of the present disclosure;

FIGS. 6 and 7 illustrates examples in which a lighting apparatus having a transformable lamp shade works according to embodiments of the present disclosure;

FIG. 8 illustrates examples in which a transformable lamp shade of a lighting apparatus, assembled with a shaft, works according to embodiments of the present disclosure; and

FIG. 9 illustrates examples in which a lamp shade is rendered to have various changes in shape or position depending on the position of a ring coupler of the lamp shade according to embodiments of the present disclosure.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

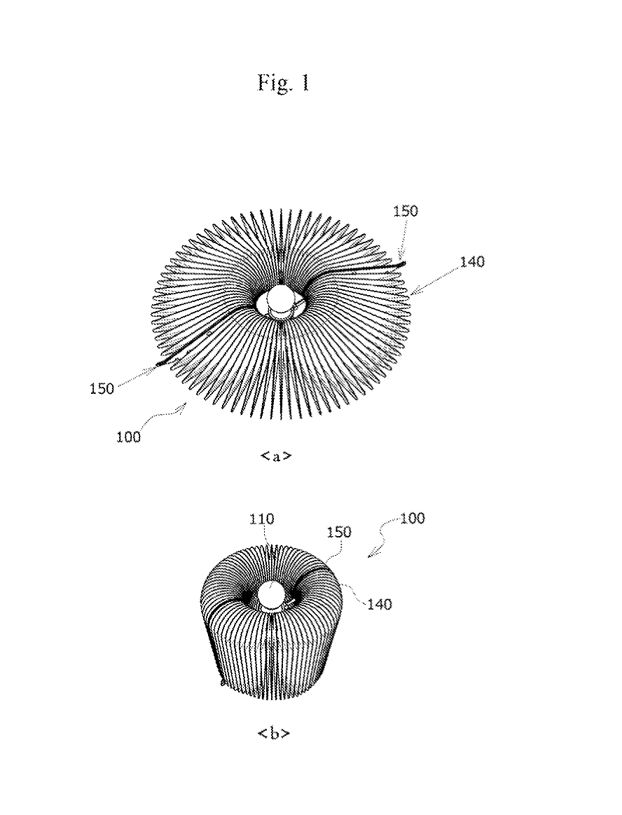

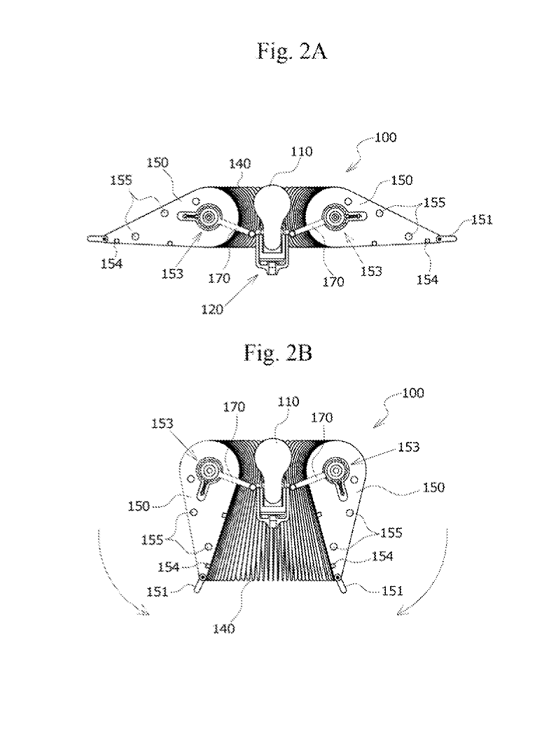

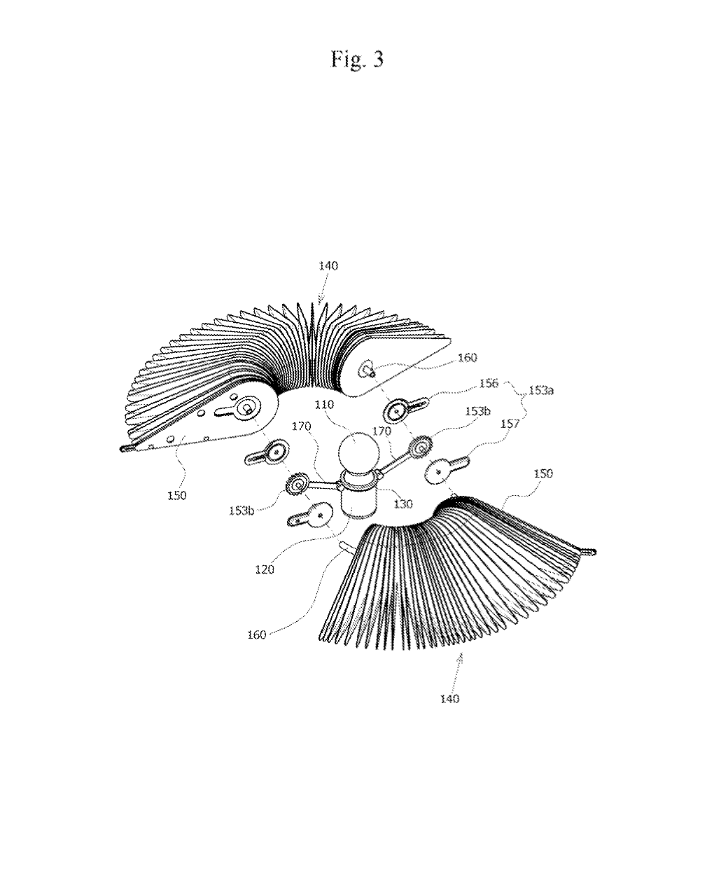

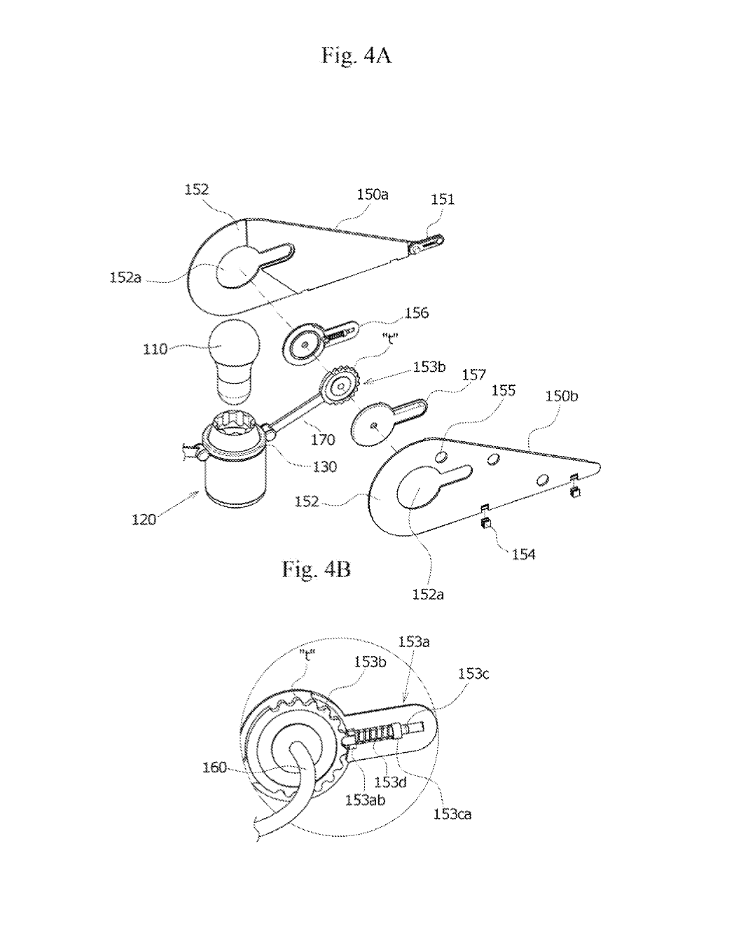

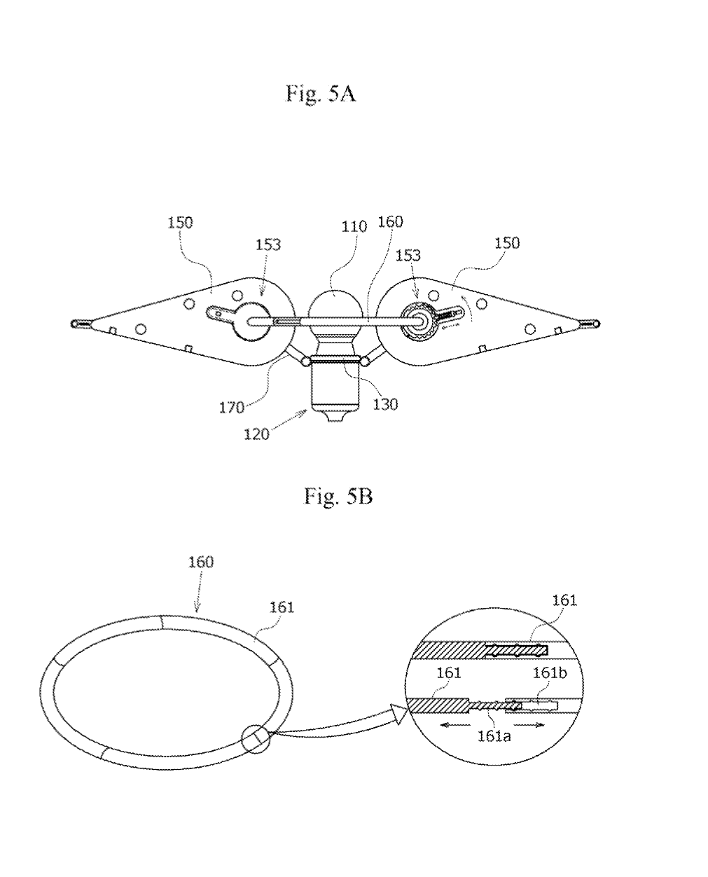

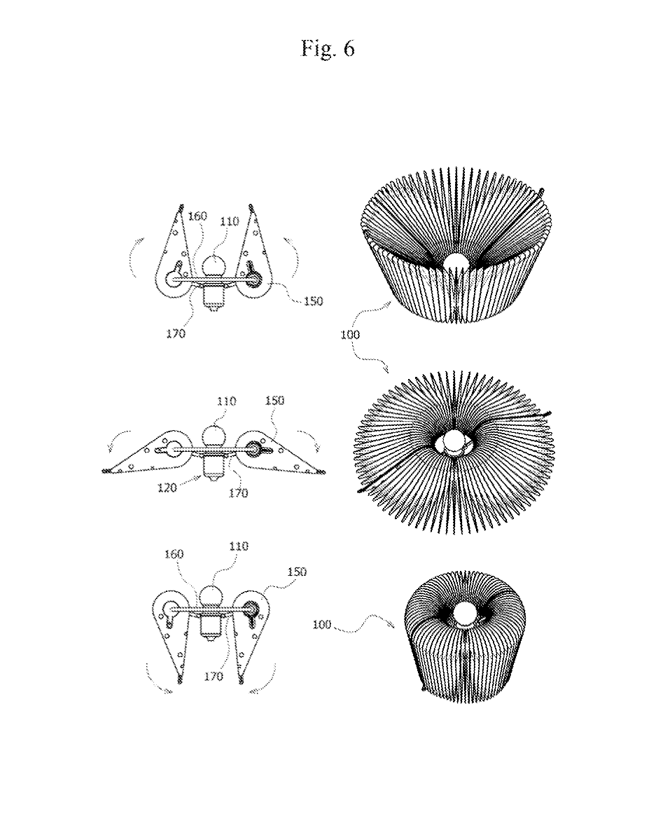

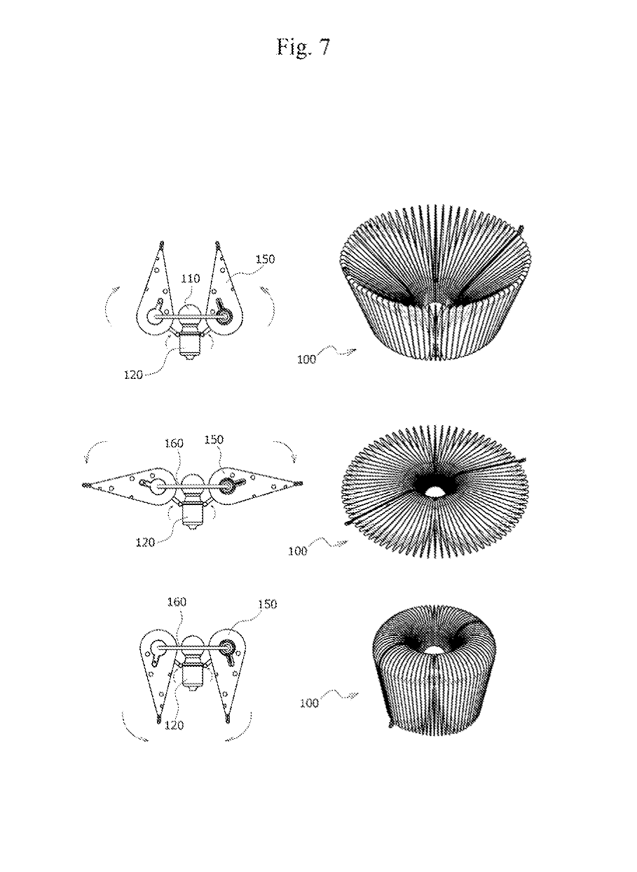

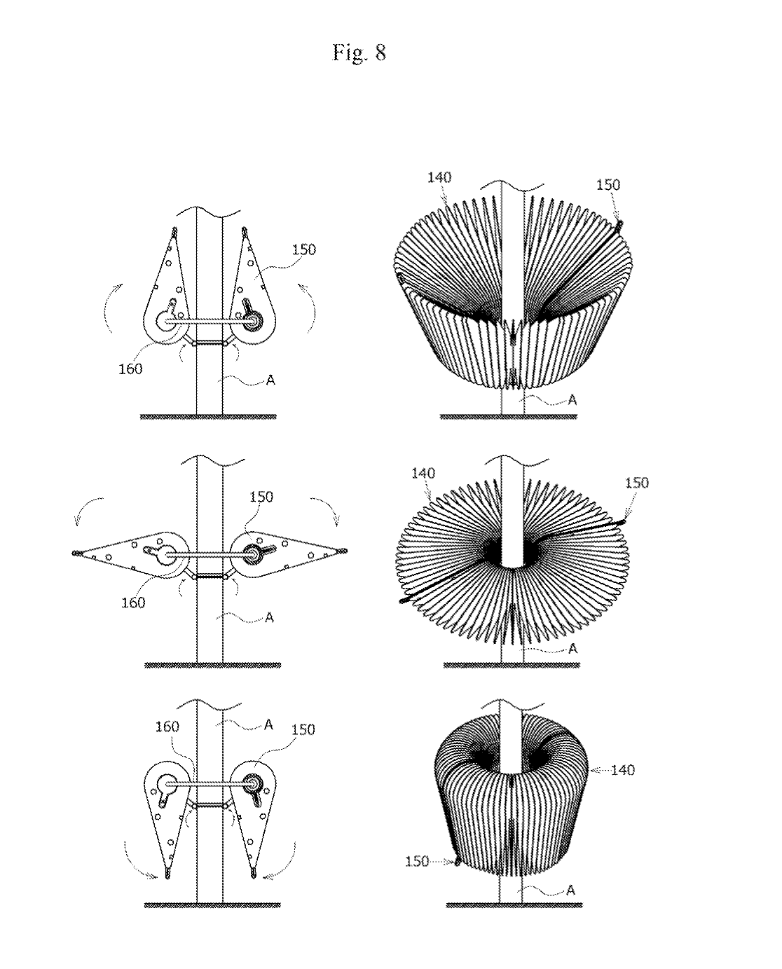

FIG. 1 is a perspective view illustrating a lighting apparatus having a transformable lamp shade according to an embodiment of the present disclosure. FIG. 2A is a cross-sectional view illustrating a lighting apparatus having a transformable lamp shade wherein the transformable lamp shade is in a first shape, according to an embodiment, of the present disclosure. FIG. 2A is a cross-sectional view illustrating a lighting, apparatus having a transformable lamp shade wherein the transformable lamp shade is in a second shape, according to an embodiment of the present disclosure. FIG. 3 is an exploded perspective view illustrating a lighting apparatus having a transformable lamp shade according, to an embodiment of the present disclosure. FIG. 4A is an exploded perspective view illustrating a supporting frame of a lighting apparatus having a transformable lamp shade according to an embodiment of the present disclosure. FIG. 48 is an expanded view illustrating a portion of the supporting frame of FIG. 4A, according to an embodiment of the present disclosure. FIG. 5A and 5B are views illustrating an example in which a lighting apparatus having a transformable lamp shade works according, to an embodiment of the present disclosure. FIG. 6 and 7 illustrates examples in which a lighting apparatus having a transformable lamp shade works according to embodiments of the present disclosure. FIG. 8 illustrates examples in which a transformable lamp shade of a lighting apparatus, assembled with a shaft, works according to embodiments of the present disclosure.

Referring to FIGS. 1 to 8, a transformable lamp shade includes a supporting bracket 130 coupling or decoupling from a shaft or a supporting member A, a cover 140 connected to the supporting bracket 130 and including a plurality of pleated sheets foldable in an accordion shape, a cover plate 150 connected with the supporting bracket 130 and the cover 140, and a ring coupler 160 provided to pass through the cover plate 150 and the cover 140 to join together the cover 140 and the cover plate 150, The ring coupler 160 has a changeable diameter or size, For example, the ring coupler 160 may be expandable or shrinkable. For example, the ring coupler 160 may include a plurality of parts 161 that are coupled with each other via a predetermined coupling. mechanism or structure. Examples of the coupling mechanism or structure are described below with reference to FIG. 5. There may be provided at. least one or more cover plates 150. For example, the cover plate 150 may include two plates, a first plate 150 and a second plate 150.

As the cover plate 150 pivots about the ring coupler 160, the cover 140 may change its shape. The cover 140 may have an accordion, hive or other various shapes, without limited thereto. The transformable lamp shade further includes a link 170 having a first end pivotally connected with the supporting bracket 130 and a second end connected with the ring coupler 160 to move up or down the ring coupler 160.

As illustrated in FIGS. 6 to 8, as the cover plate 150 pivots up or down with respect to the ring coupler 160, the cover 140 connected with the cover plate 150 may be folded or unfolded to change its shape while enlarging and shrinking.

As the ring coupler 160 may be lifted up or pressed down, the link 170 is pivoted, allowing the ring coupler 160 to move up or down. Here, the rotating portion of the link 170 may be made stiff so that it can be rotated by applying a predetermined force or more.

The shaft or supporting member A ma be coupled and firmly held by the supporting bracket 130. For example, the shaft or supporting member A may be inserted through the supporting bracket 130 and may be fastened by the supporting bracket 130.

Instead of the shaft or supporting member A, the socket 120 may be coupled to the supporting bracket 130. A bulb 110 may be fitted in the socket 120.

In the lighting apparatus 100 configured as above, as the ring coupler 160 is rotated downward of the supporting bracket 130, the bulb 110 joined to the socket 120 may be exposed to the outside of the cover 140.

In this ease, as the cover plate 150 is rotated up or down with respect to the ring coupler 160, the cover 140 may be unfolded or folded, allowing it to have various shapes.

Further, as the ring coupler 160 is shrunken, the ring coupler 160 changes its diameter and rotates up or down the supporting bracket 130, thereby changing its shape or volume. This leads the inner space of the cover 140 to increase or decrease. As such, since the inner space transforms, it may be possible to easily exchange bulbs 110 to fit the size of the inner space.

As such, exchange of bulbs 110 may be made easily regardless of the size or shape thereof, allowing for more various applications.

For example, the cover 140 may be formed of nonwoven fabric, but is not limited thereto.

According to an embodiment of the present disclosure, two or more cover plates 150 may be provided along the ring coupler 160 to stably support the cover 140. According to an embodiment of the present disclosure, two or more links 170 may be provided to stably connect the supporting ring 130 with the ring coupler 160. The supporting ring 130 may be formed in a ring shape that may be fitted over the socket 120.

The supporting ring 130 may be formed of an elastic material or elastomer that may flexibly fit the size of the supporting member A or the socket 120 coupled thereto. For example, the supporting ring 130 may expand or shrink depending on the size of the supporting member A or the socket 120. Although the supporting ring 130 is shown to have substantially a ring shape, the shape of the supporting ring 130 is not limited thereto. Any other shapes for the supporting ring 130 may also be possible as long as they hold, fasten, or couple or decouple from the supporting member A or socket 120.

For example, the supporting ring 130 may be configured to provide easier coupling/decoupling, of the supporting member A or the socket 120. For example, the supporting ring 130 may be detachably coupled with the supporting member A or the socket. In such case, the lamp shade may be applicable to pendant-type lamps or other existing lamps.

For easier coupling or decoupling between the supporting ring 130 and the supporting member A or the socket 120, the supporting ring 130 may further include an opening/closing means (not shown).

The cover plate 150 may have a handle 151 at an end thereof and a rounded portion 152 at an opposite end thereof. The ring coupler 160 passes through the rounded portion 152. The width of the cover plate 150 increases from the handle 151 to the rounded portion 152.

The handle 151 of the cover plate 150 may be configured to pivot for ease of use.

For example, the cover plate 150 includes a handle 151 at a first end thereof and a rounded portion 152 at a second end opposite the first end and through which the ring coupler 160 is inserted. The rounded portion 152 has a through-hole 152a through which a pivoting member 153 is inserted to enable the cover plate 150 to pivot about the ring coupler 160. For example, at the through-hole 152a may be provided a pivoting member 153 that holds or fastens the ring coupler 160, with the ring coupler 160 coupled through the pivoting member 153, and that allows the cover plate 150 to pivot about the ring coupler 160.

The pivoting member 153 includes a body 153a, a disc-shaped sprocket 153b provided in the body 153a, coupled with an end of the link 170, having the ring coupler 160 pass therethrough and fastened, and having a toothed outer edge t, a locking rod 153c provided in the body 153a elastically stuck to the toothed edge t of the sprocket 153b to control the pivoting of the cover plate 150, and a spring 153d provided in the locking rod 153c.

Thus, as the user turns around the cover plate 150 by the handle 151 of the cover plate 150, the cover plate 150 pivots about the sprocket 153b provided inside the pivoting member 153.

For example, as a rotational force is applied to the cover plate 150 while the ring coupler 160 is coupled and fastened by the sprocket 153b, the locking rod 153c runs over the toothed edge t and thus the spring 153d elastically slides to move back and forth, enabling the cover plate 150 to pivot.

By an elastic force of the spring 153d, an end of the locking rod 153c may be engaged or released from the toothed edge t, thereby enabling the pivoting of the sprocket 153b.

Accordion-shaped, non-woven covers 140 are attached to two opposite sides of the sprocket 153b, and thus, as the sprocket 153b pivots, the covers 140 may change their shape.

The body 153a in which the locking rod 153c is placed includes a housing jaw 153ab to elastically support an end of the spring 153d. The locking rod 153c includes a rod jaw 153ca to elastically support another end of the spring 153d.

Accordingly, the locking rod 153c may be stuck or engaged and released from the sprocket 153b while slidingly moved back and forth by an elastic force of the spring 153d.

Thus, the cover plate 150 may pivot with respect to the ring coupler 160 having the sprocket 153b.

The cover plate 150 may include a first plate 150a and a second plate 150b symmetrical with the first plate 150a. The first plate 150a and the second plate 150b may be coupled and fastened to each other.

The first and second plates 150a and 150b each may include at least one elastic clamp 154 on an edge thereof. The clamp 154 may be configured in various forms or types, such as screw couplers or male-female couplers.

Two opposite sides of the cover plate 150 may include at least one attaching means 155 that enables the attaching and detaching of the cover 140.

The attaching means 155 may include, but not is limited to, Velcro tapes or magnets or any other means to attach or detach the cover 140.

The body 153a of the pivoting member 153 may include a female housing 156 and a male housing 157 that are symmetrical with respect to each other and are coupled with each other.

The locking rod 153c having the sprocket 153b and the spring 153d placed inside may be put in the female housing 156, and the male housing 157 may be fitted and fastened into the female housing 156. Accordingly, easier assembly or disassembly may be possible.

According to an embodiment of the present disclosure, the female housing 156 may be formed separately or integrally with the first plate 150a to prevent separation therebetween.

The ring coupler 160 may be formed of an extendable/shrinkable member that may change its size or diameter. The extendable/shrinkable member may be implemented in various manners

For example, the ring coupler 160 may include multiple parts 161 each having a predetermined length. Each part 161 of the ring coupler 160 has two opposite ends, one of which has at least one protrusion 161a while the other has at least one depression 161b corresponding to the protrusion 161a. Such protrusions 161a and depressions 161b may be fitted into each other to make couplings between the parts 161 of the ring coupler 160, thereby leading to the whole ring coupler 160 assembled.

The parts 161 of the ring coupler 160, each, may be formed of an elastic material that allows the protrusion 161a to be elastically fitted into its corresponding depression 161b.

The parts 161 of the ring, coupler 160 may be expanded or shrunken to increase or decrease the diameter or size of the ring coupler 160, thereby allowing the cover 140 to change its size or volume.

The protrusion 161a may be partially pulled out of the depression 160 while remaining fitted and fastened into the depression 160 in order to increase the diameter of the ring coupler 160 while keeping the ring coupler in the ring shape.

Alternatively, other various expandable/shrinkable means may be adopted for the ring coupler 160. For example, the parts 161 of the ring coupler 160 may be configured like those of a foldable antenna, but not limited thereto.

As such, the use of the expandable/shrinkable means allows the ring, coupler 160 to move up or down while increasing or decreasing the size or diameter of the ring coupler 160 as the link 170 pivots.

As the ring coupler 160 is moved down, the bulb 110 fitted into the socket 120 may be exposed to the outside, allowing for provision of more light and easier bulb exchange.

The volume or size of the cover 140 may be adjusted (e.g., increased or decreased) by changing the diameter of the ring coupler 160, allowing various sizes of bulbs to be used.

A battery (not shown) may be connected to the socket 120 under the socket 120 to power the bulb 110 even without connection to an outlet.

An operation of the lighting apparatus 100 is described below. As the cover plate 150 is pivoted up or down by the handle 151 in the directions marked with arrows of FIG. 6 or 7, the pivoting member 153 pivots about the sprocket 153b, leading to the cover 140 transforming

The cover 140 may be formed of accordion-shaped or folded non-woven fabric with elasticity, and thus, the cover 140 may readily change its shape as the pivoting member 153 pivots.

FIG. 1(b) shows an example in which the cover plate 150 is pivoted and directed downwards. However, the pivot angle of the cover plate 150 may be adjusted to put the cover 140 in a desired shape.

The transformed cover 140 enables creation of various ambient atmospheres and the adjustment of light emitted to the outside.

As the ring coupler 160 is pushed up or down, the link 170 is pivoted to allow the ring coupler 160 to move up or down while increasing the diameter of the ring coupler 160 thanks to the expandable/shrinkable parts 161 of the ring coupler 160.

As the cover plate 150 is pivoted down with the ring coupler 160 moved down, the bulb 110 may be exposed to the outside to allow for more external light. Further, in such position, the bulb 110 may be changed easier.

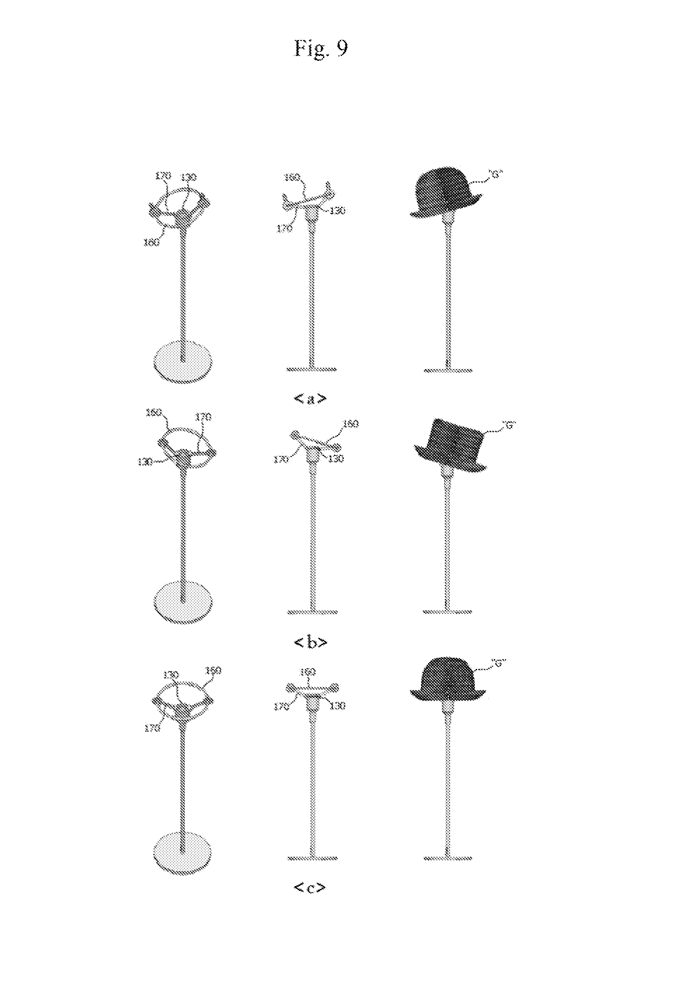

FIG. 9 illustrates examples in which a lamp shade is rendered to have various changes in shape or position depending on the position of a ring coupler of the lamp shade according to embodiments of the present disclosure.

As an end of the ring coupler 160 is pushed down while its opposite end is pushed up, the link 170 is pivoted as shown in FIG. 9, so that the ring coupler 160 is inclined to the left as shown in FIG. 9(a). In an opposite position, the ring coupler 160 may be inclined to the right as shown in FIG. 9(b). Accordingly, various interior designs may be achieved.

For example, the ring coupler 160 may be positioned so that an end thereof is placed lower while another end is placed higher, thereby creating various atmospheres.

According to an embodiment of the present disclosure, the lighting apparatus may be applicable to various types of lights or lamps, such as chandeliers or stand or desk lamps.

While the inventive concept has been shown and described with reference to exemplary embodiments thereof, it will be apparent to those of ordinary skill in the art that various changes in form and detail may be made thereto without departing, from the spirit and scope of the inventive concept as defined by the following claims.

What is claimed is:

1. A transformable lamp shade, comprising:
a supporting bracket coupling or decoupling from a shaft or a supporting member;
a cover connected to the supporting bracket and including a plurality of pleated sheets foldable in an accordion shape;
a cover plate connected with the supporting bracket and the cover;
a ring coupler provided to pass through the cover plate and the cover to join together the cover and the cover plate, the ring coupler having a changeable diameter, wherein as the cover plate pivots about the ring coupler, the cover changes its shape; and
a link having a first end pivotally connected with the supporting bracket and a second end connected with the ring coupler to move up or down the ring coupler.

2. A lighting apparatus comprising the transformable lamp shade of claim 1, wherein the supporting member is a socket to Which a bulb is detachably coupled.

3. The lighting apparatus of claim 2, wherein the cover plate includes a handle at a first end thereof and a rounded portion at a second end opposite the first end and through which the ring coupler is inserted, wherein the width of the cover plate increases from the handle to the rounded portion, wherein the rounded portion has a through-hole through which a pivoting member is inserted to enable the cover plate to pivot about the ring coupler.

4. The lighting apparatus of claim 3, wherein the pivoting member includes a body, a disc-shaped sprocket provided in the body, coupled with an end of the link, having the link coupler pass therethrough, and having a toothed outer edge, a locking rod provided in the body elastically stuck to the toothed edge of the sprocket to control the pivoting of the cover plate, and a spring provided in the locking rod.

5. The lighting apparatus of claim 4, wherein the body has a housing jaw to elastically support an end of the spring and a rod jaw to elastically support another end of the spring.

6. The lighting apparatus of claim 5, wherein the cover plate includes a first plate and a second plate, and wherein a plurality of elastic clamps couple with edges of the first and second plates to fasten the first and second plates.

7. A lamp shade, comprising:
a supporting bracket detachably coupled with a supporting member;
a cover coupled with the supporting bracket and including a plurality of pleated foldable sheets;
a cover plate coupled with the supporting bracket and the cover;
a ring coupler passing through and coupled with the cover plate and the cover, the ring coupler formed of a shrinkable material, wherein the cover plate is pivoted about the ring coupler to change the shape of the cover; and
a link having a first end pivotally connected with the supporting bracket and a second end connected with the ring coupler to move up or down the dug coupler.
